(19) United States
(12) Patent Application Publication
(10) Pub. No.: US 2006/0071070 A1
(43) Pub. Date: Apr. 6, 2006

(54) Consumer oriented identification package for tracking and security and method of using same

(76) Inventor: Michael C. Maier, Carthage, MO (US)

Correspondence Address: WARD KRAFT, INC., P.O. BOX 938, FORT SCOTT, KS, 66701, US

(21) Appl. No.: 10/951,177

(22) Filed: Sep. 27, 2004

(51) Int. Cl. G06Q 30/00; G07G 1/14; G08B 13/14

(52) U.S. Cl. 235/385; 340/572.1; 705/14

(57) ABSTRACT

The present invention is directed to a radio frequency identification (“RFID”) system that has been packaged for use in the home or small office environment. A package suitable for distribution through a retail sales outlet is provided and includes a series of tags, which may be active, passive or semi active, and which are capable of retaining and transmitting machine readable information, a scanner and/or reader for reading information obtained from the tags, an antenna for collecting signals from said tags and machine readable instructions for configuring the components of said package to enable a home or office computer to receive and read the information collected from the tags. The package may include instructions on obtaining additional tags as well as upgrading the system or other marketing or promotional information. The invention also includes a method for using the system and package of the present invention as well as preparing the package.

### CROSS-REFERENCES TO RELATED APPLICATIONS

None.

### FIELD OF THE INVENTION

The present invention relates to systems that may be employed in the tracking, identification and providing security to consumers in a home or small office environment. More specifically, the present invention includes a number of pre-determined components which will aid a home or small office user in locating particular personal effects, assets or even assist in monitoring pets, children or others located on the property. The package includes at least a number of radio frequency identification (“RFID”) tags, readers, antennas and scanners, or combinations thereof as well as integration software that enable a small user to implement a system at a relatively reduced cost.

### BACKGROUND OF THE INVENTION

Systems using RFID technology and RFID itself has been known for some time and the technology has been used in a wide range and variety of applications. Typically, RFID has been employed to identify articles such as containers or in “asset tracking” applications. RFID tags may be provided in several formats, active, passive and semi-active, and can operate over a number of frequency ranges depending on the requirements of the end users as well as have varying read ranges. The tags themselves have a small memory such that when the tag is attached to a device, the tag can be used to identify the particular device to which it has been connected. Depending on the amount of memory available or the type of tag that is used, particular details relating to the article or item to which the tag has been attached can be added or modified. Such additional details, as in the example of an inventory management system, may include date of manufacture, plant of manufacture, ship dates, receive dates, expiration dates, lot numbers and the like. Such inventory management systems are unfortunately, currently quite expensive and it has been estimated that it may cost upwards of $100,000 to implement an RFID tracking system in a particular location. Such sums are typically well out of the range of small offices and home users that could certainly take advantage of the technology if it was more affordable or readily available such as through retail outlets and the like. Some exemplary RFID devices are provided in U.S. Pat. Nos. 5,990,794 and 5,949,335.

RFID has also been used for electronic registration of product transactions and for eliminating theft and unauthorized returns. Exemplary systems include those described in U.S. Pat. Nos. 5,978,774, 6,018,719 and 6,085,172. These systems again rely on the assignment of unique identifiers to the product which can be read at the shelf and point of purchase locations. The information from the tag is then recorded and retained for recordation purposes and may be used at a later time to indicate purchase activity, warranty information and the like.

While such systems are extremely efficient they are again quite costly and normally out of the range of the average consumer from a cost perspective. These systems typically require the purchase of numerous hardware components including scanners, readers, antennas as well as thousands if not millions of tags in order to implement an inventory and asset management system. In addition, the systems require information technology support, software integration and many other resources that simply are not available to the average consumer. Moreover, many RFID technology providers do not currently support situations considered to be in the “low end” of tag or system volume ranges.

What is needed therefore is a pre-packaged system which a consumer can readily purchase and utilize in home or small office environment.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one exemplary embodiment of the present invention, a consumer radio frequency identification package (RFID package) for use in home or small office environments, is provided and includes a package that is configured for sales to consumers in a retail environment. The package contains a plurality of radio frequency identification tags, with at least one of the tags being rewritable and with each of the tags having the ability to retain discrete machine readable information so as to be able to identify each of the tags and an object to which it is affiliated or attached. The package includes at least one antenna for receiving signals from at least one rewritable tag; at least one scanner for receiving signals from the plurality of tags; and a series of machine readable instructions to enable reading of the machine readable information received from the tags and to write to at least the one rewritable tag.

The package would be utilized in connection with a computer that has already been installed or is in existence at the home or small office location. The tags from the package would be used in the tracking and identification of articles or items such as those selected from the group including electronics, valuables, keys, documents, files, tools, parts, toys, utensils, children and pets and combinations thereof.

The package may also be provided with a series of carriers that can be used to attach, affix or otherwise connect the tag directly to the article or item that is to be identified. Typically, the carriers may include an adhesive component, such as a permanent, removable or repositionable adhesive so that the consumer may easily connect the tag to the article. Other carriers or connection means can of course be used such as hook and loop type fasteners.

In order to entice the consumer to make additional purchases or to enhance the system that has been provided, the package may also include incentives, coupons and combinations for purchasing additional tags, hardware, system upgrades and combinations thereof.

In a still further exemplary embodiment of the present invention, a system for providing radio frequency identification for home and small office use, is described and includes a series of tags, with each of the tags being capable of retaining and transmitting machine readable indicia relating to an item to which each tag has been associated. A computer, normally which is already available at the home or small office location is used to read information that is transmitted by each of the tags when each of the tags transmits its machine readable indicia.

The system also includes an antenna which is provided for capturing a signal incorporating the machine readable indicia from at least one of the tags. A scanner is also provided for activating and capturing machine readable indicia from at least one of the tags so that the home or office user can scan the particular environment for the article in the event the signal has not been captured by the antenna. The system also utilizes a communication device for connecting the computer to the antenna and the scanner so as to enable reading of the tags. In order to integrate the components of the system, a series of machine readable instructions is provided which allows the computer to read the machine readable indicia captured by at least one of the antenna and the scanner. The system also includes a plurality of attachment devices that are used for connecting the series of tags to articles and items to be identified and tracked within a home or small office.

The system of the previously described embodiment may be provided with a number of pre-encoded tags such that the user or purchaser does not need to specifically write to each tag, or the system may contain a combination of pre-encoded tags and tags that still need to be provided with indicia or all blank tags that need information written to the tags.

In a yet still further embodiment of the present invention, a method of using a system for providing radio frequency identification in a home or small office environment, is provided and includes the steps of initially obtaining a package from a retail outlet. The package includes a series of radio frequency identification tags having machine readable indicia; at least one scanner for receiving machine readable indicia from the tags; at least one antenna for collecting signals from the tags; and machine readable instructions to enable reading of the machine readable indicia from the tags by a pre-established computer located in a home or small office. At least one article or item to be tracked or identified is located in the home or office environment. At least one tag from the series of tags is associated with at least one article or item. Next, the home or small office user can scan for at least one article or item having an associated tag. The machine readable indicia is then read from the article or item having the associated tag so as to be able to locate the article or item in a home or small office.

The foregoing method may include the additional steps of removing the tags from one or more previously identified articles and then rewriting to the tag or tags after the tag has been used so that the tag, or the information on the tag, can be changed so that the tag may be used with a different article.

In a yet still further embodiment of the present invention, a method of preparing a home or small office radio frequency identification package, is described and includes the steps of initially obtaining a series of radio frequency identification tags at a first location and then pre-encoding each of the tags with information from a pre-determined data set. The pre-encoded tags are then packaged along with additional components and the package is delivered to a retail environment for purchase by individual consumers for use in a home or small office environment at a distinct second location remote from the first location.

The foregoing embodiment also includes instructions for the ordering of additional pre-encoded tags from the first location. Ordering of additional tags can occur over a global communications network, through the mail, via courier or electronic transmissions such as e-mail and facsimile. As used in this embodiment, the retail location can be a website such as that provided over a global communication network, a fixed store location, kiosk or combinations thereof.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts the package of the present invention and displays the items included with the package;

FIG. 2 illustrates a schematic of the system of the present invention;

FIG. 3 provides an exemplary flow diagram demonstrating the method of using the system and package of the present invention; and

FIG. 4 shows a further block diagram depicting an additional exemplary method of the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Surprisingly, it has been found that economies can be generated for small office and home users thereby enabling ready and convenient access for such users without incurring significant costs. It has been discovered that while inventory and asset management systems require the purchase of significant numbers of tags, and other components in order to implement the system, the tags can then be repackaged and resold along with minimal amounts of hardware and software components so that home and small office users can implement a small scale asset management system.

It has been found that the tags can be written to or encoded with machine readable information that is selected from a predetermined group of assigned reference items, with typically one item being assigned to each tag. The data set or information set from which the encoding is selected includes those elements that would be relatively constant in any home or small office environment. For example, a home may have multiple pets, electronics such as televisions, stereos, remote controls, cell phones and the like as well as valuables, e.g. jewelry, art, antiques and other items that are routinely located in homes and small offices. Thus, groups of tags can be pre-encoded with this generic or fixed information so that a retail consumer may purchase the package and then attach the tags directly to predefined articles. The tags may then be labeled, such as with a pressure sensitive label to indicate that the tag has been pre-encoded for a particular item, such as a pet, TV, appliance or the like so that the user knows which tags to associate with which items without having to first encode or write to the tag. The user can obviously personalize the information such as by changing the “pet” designated to “dog” or “spot.”

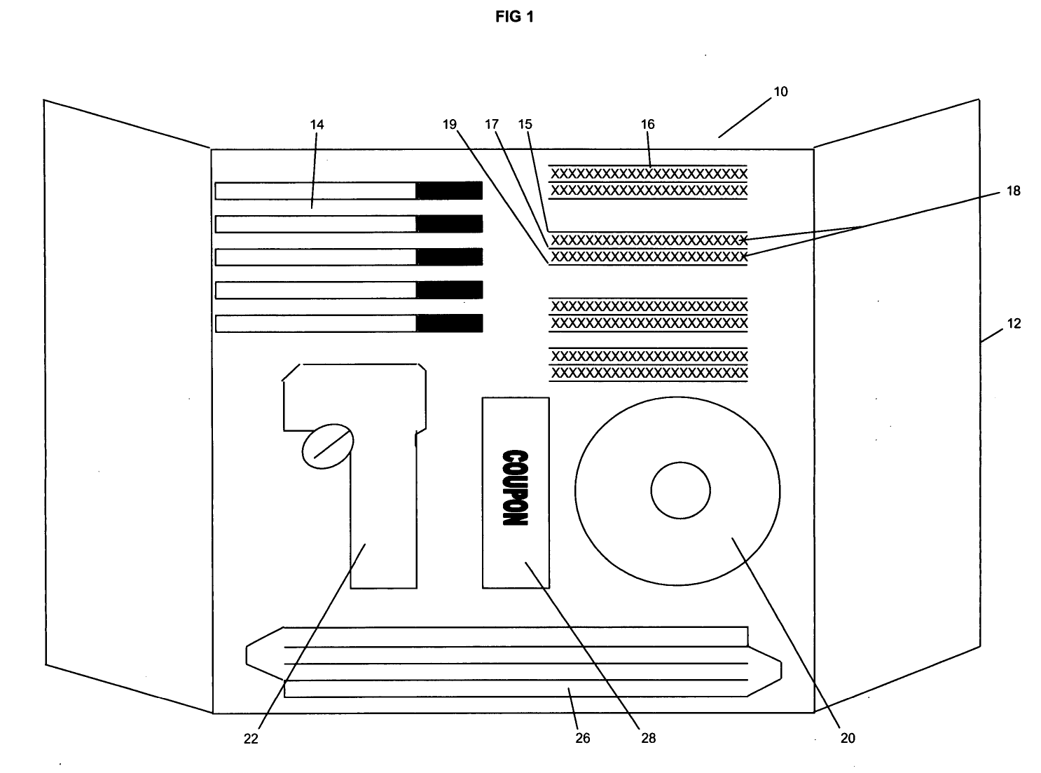

Reference is now directed to FIG. 1 of the presently described embodiments. FIG. 1 provides a package, such as a box or carton, generally designated by reference numeral 10. The package is intended to be a retail type package and will typically comprise a paperboard box that is shrink wrapped with plastic or film to protect the contents. It should be anticipated that the package may comprise any suitable structure that may be used in a retail environment such as plastic containers, bags and the like. In addition, the package 10 would be provided with marketing indicia to attract the potential customer to the package 10.

The package 10, as provided in the present configuration is depicted as a box or carton and is provided with one or more closure flaps 12 and includes a series of radio frequency identification tags 14 (“RFID”) that may be passive, semi-passive or active tags. Preferably, the tags are active or battery powered passive tags that have a power source such as a battery connected to the tag so that the tag may transmit a signal and does not require activation in order to transmit as in the case of most unassisted passive tags. Batteries and battery powered tags are available from a number of sources and one exemplary source is Graphic Solutions International of Burr Ridge, Ill. and PowerPaper Ltd. of Tel Aviv, Israel. It should be understood that other tags such as passive tags may also be used in connection with the present invention but such tags may require additional different components in the pacakge.

The number of tags provided in a package would be determined based on particular price points. For example a basic package may only include 10 tags, an intermediate package 25 and a deluxe package 50 and so on. Supplementary packages of tags could be purchased separately to expand the initial system purchased by the consumer.

The package 10 can also include a number of carriers 16. The carriers 16 used in the present illustration are adhesive based carriers and include a substrate 17 and first and second release liners 15 and 19 which when removed expose adhesive 18 so as to enable the tag to be attached to the article that is to be identified. Release liners may be provided on both sides, such that the tag can be attached to one side and the other exposed adhesive attached to the article.

The adhesive may be permanent, removable or repositional. In an exemplary arrangement, the tag 14 is connected to the carrier 16 through one adhesive layer after the release liner has been peeled away and then the second release liner is removed so that the tag may be connected to the article that is to be tracked or identified. The number of carriers provided in a package will normally exceed the number of tags so that the tags can be removed, such as through the use of a repositional or removable adhesive and reused on other items for identification. As such, the carrier would be stripped off and a new carrier used. Thus, preferably, a removable or reusable adhesive would be used such as MIGHTY TAC® available from Ward/Kraft, Inc. of Ft. Scott, Kans.

In addition to adhesive, other attachment devices may also be used such as hook and loop fasteners, clips, bands and the like.

The package 10 further includes a series of machine readable instructions 20 which are provided in a convenient to use form such as the compact disc that is depicted in the drawing. The instructions 20 will enable the user to utilize the home or office computer to read and display information encoded on the tag. The computer would normally be pre-existing and will not be included with the package for sake of economies, although it is within the scope of the invention that a computer could be purchased along with the package.

Also included in the package 10 is a scanner or reader 22, which preferably will be a hand held scanner so that the consumer may move around the home or office to seek out the item to be located if it is not in the position where the user originally anticipated finding the item. Hand held scanners are available from a number of sources such as Zebra Technologies of Vernon Hills, Ill.

The consumer will also be provided with one or more antennas 26 in the package 10. The antennas will include a wire encased in insulation that may be adhered or otherwise attached to a door frame, window frame or elsewhere in room or used in combination with other antennas to coordinate or triangulate the exact position of an item. Thus, when a tagged article, carrying an active or battery powered tag, leaves the room the antenna would pick up the signal carrying information related to the article and pass the information to the home or office computer or reader so that a record is created about the departure of the item from its location.

The packing may also include a coupon 28 or other incentive or promotional material which may relate to the next purchase of components to upgrade the system, purchases of additional tags or offers for related products or services.

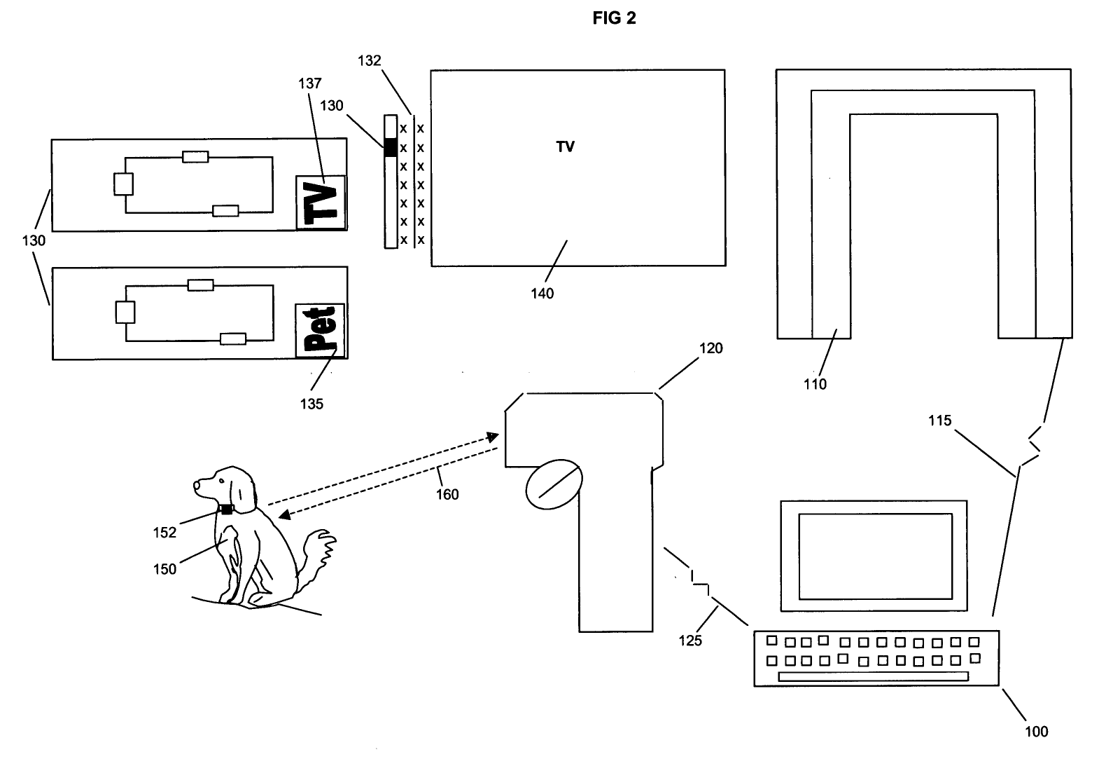

Attention is now directed to FIG. 2 of the present invention in which a high level schematic is provided of the system. As can be seen from the illustration, a computer 100 is connected to an antenna 110 and scanner 120 via communication devices 115 and 125. As provided in the drawing, the antenna 110 has been configured around an entrance such as a door way so that the antenna can be used to track a pet leaving the room or any object to which an active or battery powered tag has been applied. The communication devices may be wires or cords or may comprise a wireless system in which the information is sent back to the computer when information has been received. In situations where a passive tag is used, the reader/scanner would have to emit a sufficient energy pulse to activate the tag so that the tag transmits a signal back to the scanner/reader.

The system also includes a number of tags 130 which may be provided with identifying indicia 135 and 137 showing what information has been previously encoded onto the tags. As depicted in the drawing label 135 has been encoded for a pet and 137 for a television or “TV.” The labels for the tags could be provided in any number of formats such as “pet 1”, “pet 2”, “pet 3”, “TV1”, “TV2”, etc. and would be offered in the basic package configuration. The consumer could of course rewrite to the tags and designate specific information such as the name or species of the pet, the type of appliance, or add some other information or designation which may not be part of the original packaging.

As provided in FIG. 2, an article has been tagged for identification such as a television 140. The TV 140 has a tag 130 affixed via an adhesive carrier 132. In addition, as is depicted a pet 150 has also been tagged 152. It should however be readily understood that any household item can be tagged for identification and the items may be selected from a group including electronics, valuables, keys, documents, files, tools, parts, toys, utensils, children and pets and combinations thereof.

In use, for example the hand held scanner 120 receives a signal 160 from the active tag 152 when the object that has been tagged is in the proximate range of the scanner. For example, some active tags and even certain battery powered tags have a read range of about 30 feet if there is not significant interference in the vicinity of the signal.

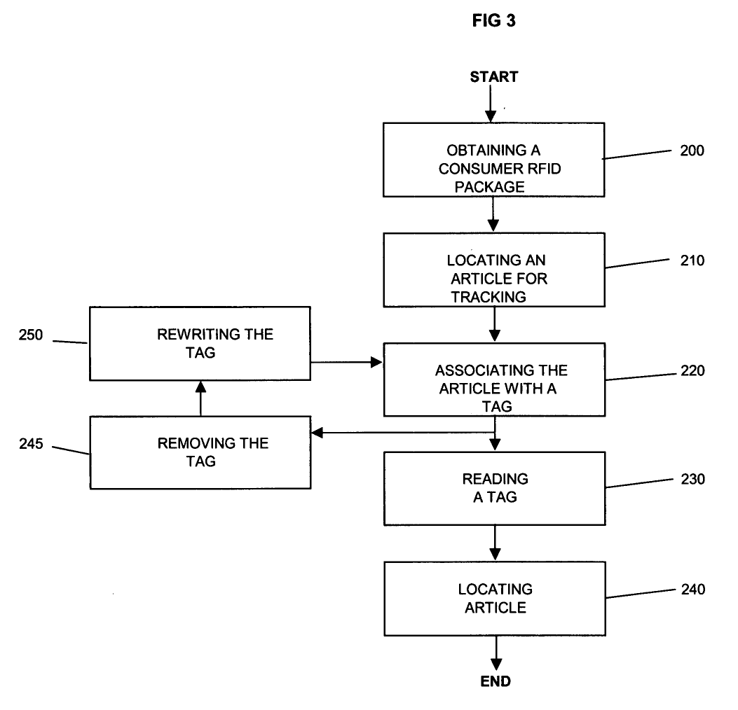

Turning now to FIG. 3 of the presently described invention, a block diagram is presented and includes as a first step 200 obtaining a consumer RFID package as that has been previously described in respect of FIG. 1. Once the package has been purchased, in this example from a retail store location, the consumer then locates or identifies articles or items that he or she would like to tag for the purpose of finding them later at step 210. Next, the article is associated with a tag at step 220 such as through the use of an adhesive carrier as previously described. Once the tag has been attached to the article at step 220 it is capable of being read at step 230 either through the use of a scanner or after the tagged item has passed through an area where the signal can be read by an antenna. The reading will then help the user locate the article at step 240.

The package as contemplated by the present invention also enables the user to reuse the tags through the use of reusable carriers. The user can remove a tag at step 245, strip off the carrier and apply a new carrier to place the tag on a new article. If the user has the capability to rewrite or re-encode the tag, then that is accomplished at step 250. If no rewrite capability has been provided or obtained, then the user would move the previously encoded tag to a similar type of item that he or she wishes to identify, for example from one TV to another. The user of course is not so limited and could use his or her own imagination to tag other articles. For example, a TV encoded tag could be placed on artwork, so long as the user kept an appropriate record. Alternatively, the encoded tags could simply be provided with an alpha or numeric sequence or both so that the user would then assign an item to a particular number with the numbers provided.

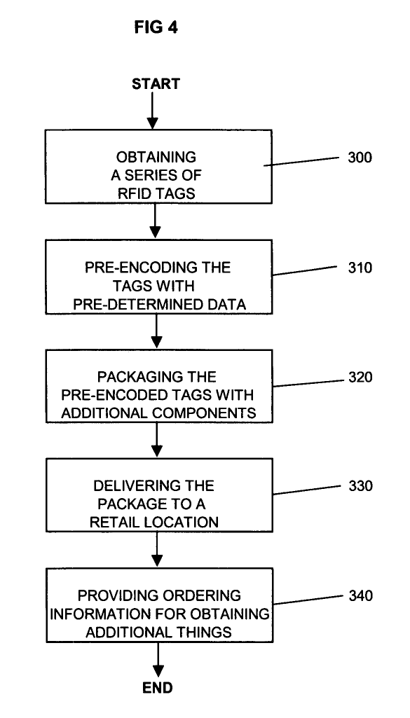

FIG. 4 provides as still further embodiment for the present invention and includes a first step 300 of obtaining a series of RFID tags at a first location. The first location may be a manufacturer that already has an asset management system in place and is regularly receiving or manufacturing a supply of tags for use in marking and identifying products or inventory. The first location may be an “aggregator” an entity that uses its purchasing power to buy components at discounted levels and then repackages the components for subsequent resale to consumers or end users. Where the first location is a manufacturer that uses the tags for its own operation then some of these tags would be diverted for sale in the retail package environment as provided herein.

Next, the tags would be pre-encoded with either pre-determined codes or data that corresponds with common household or office items or alternatively simply provided with sequential alpha and/or numeric codes for use in tracking assets at step designated by reference numeral 310.

Once the relevant number of tags has been encoded and a basic, intermediate or deluxe arrangement coordinated, the tags are then packaged along with other components at step 320. Such other components may include antenna, scanners, machine readable instructions, human readable instructions, promotional or marketing literature and the like. The package can of course contain any sort of elements that the manufacturer may want to provide or a sponsor may wish to offer.

The package is then delivered or made available to a retail outlet at step 330. The retail outlet may include a fixed store location, kiosk, website provided over a global communication network or other suitable location.

In addition, the package would provide instructions on obtaining additional tags at step 340. The tags may be supplemental to those already in use or be replacement tags once the battery life of the tag has expired.

It will thus be seen according to the present invention a highly advantageous consumer RFID package has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A consumer radio frequency identification package for use in home or small office environments, comprising;
a package configured for sales to consumers in a retail environment;
a plurality of radio frequency identification tags, at least one of said tags being rewritable and each of the tags having the ability to retain discrete machine readable information to identify each of said tags and an object to which it is affiliated;
at least one antenna for receiving a signal from said at least one rewritable tag;
at least one scanner for receiving signals from said plurality of tags; and
a series of machine readable instructions to enable reading of said machine readable information received from said tags and to write to said at least one rewritable tag.

2. A package as recited in claim 1, wherein said package further includes a number of carriers to be used in attaching said plurality of tags to items to be identified and tracked.

3. A package as recited in claim 1, wherein at least some of said carriers include an adhesive.

4. A package as recited in claim 1, wherein machine readable information is pre-encoded into a portion of said plurality of tags.

5. A package as recited in claim 4, wherein said pre-encoded information includes identifiers for assets selected from a group including electronics, valuables, keys, documents, files, tools, parts, toys, utensils, children and pets and combinations thereof.

6. A package as recited in claim 1, wherein said package further includes machine readable instructions for rewriting said at least one rewritable tag.

7. A package as recited in claim 1, wherein said package further includes incentives, coupons and combinations for purchasing additional tags, hardware, system upgrades and combinations thereof.

8. A package as recited in claim 3, wherein said adhesive is selected from a group including permanent, removable, repositionable and combinations thereof.

9. A system for providing radio frequency identification for home and small office use, comprising;
a series of tags, with each of said tags capable of retaining and transmitting machine readable indicia relating to an item to which each tag has been associated;
a computer for reading information transmitted by each of said tags when said each of said tags transmits its machine readable indicia;
an antenna for capturing a signal containing said machine readable indicia from at least one of said tags;
a scanner for activating and capturing machine readable indicia from at least one of said tags;
a communication device for connecting said computer to said antenna and said scanner;
a series of machine readable instructions for allowing said computer to read said machine readable indicia captured by at least one of said antenna and said scanner; and
a plurality of attachment devices for connecting said series of tags to articles and items to be identified and tracked within a home or small office.

10. A system as recited in claim 9, wherein said system is packaged for distribution through retail sales channels.

11. A system as recited in claim 9, wherein at least a portion of said tags contains previously encoded machine readable indicia.

12. A system as recited in claim 9, wherein at least a portion of said tags are rewritable.

13. A system as recited in 9, wherein said series of tags includes at least one rewritable tag.

14. A system as recited in claim 13, wherein said machine readable instructions include instructions for writing information to said at least one rewritable tag.

15. A method of using a system for providing radio frequency identification in a home or small office environment, comprising the steps of;
obtaining a package from a retail outlet, said package including a series of radio frequency identification tags having machine readable indicia; at least one scanner for receiving machine readable indicia from said tags; at least one antenna for collecting signals from said tags; and machine readable instructions to enable reading of said machine readable indicia from said tags by a pre-established computer located in a home or small office;
locating at least one article or item to be tracked or identified;
associating at least one tag from said series of tags to said at least one article or item;
scanning for said at least one article or item having an associated tag; and
reading said machine readable indicia from said article or item having said associated tag so as to be able to locate said article or item in a home or small office.

16. A method as recited in claim 15, wherein said at least one article or item is selected from a group including electronics, valuables, keys, documents, files, tools, parts, toys, utensils, children and pets and combinations thereof.

17. A method as recited in claim 15, wherein the step of associating includes adhering, affixing, connecting and tying.

18. A method as recited in claim 15, including a further step of providing a series of carriers prior to the step of associating so that each of said tags may be connected to said article or item.

19. A method as recited in claim 15, wherein said carriers are provided with adhesive.

20. A method as recited in claim 15, including an additional step of rewriting to a tag to identify a different article after the step of associating a tag with an article.

21. A method as recited in claim 20, including an additional step of removing the tag from the article before the step of rewriting to the tag.

22. A method of preparing a home or small office radio frequency identification package, comprising the steps of;
obtaining a series of radio frequency identification tags at a first location;
pre-encoding a least a portion of said tags with information from a pre-determined data set;
packaging said pre-encoded tags along with additional components;
delivering said package to a retail environment for purchase by individual consumers for use in a home or small office environment at a distinct second location remote from said first location.

23. A method as recited in claim 22, wherein said additional components are selected from a group including scanners, antennas, tag carriers, machine readable instructions and combinations thereof.

24. A method as recited in claim 22, wherein the pre-determined data set contains information about common household and small office goods or contents.

25. A method as recited in claim 22, wherein said packaging includes carrier assemblies for said tags.

26. A method as recited in claim 22, including a further step of providing ordering information for obtaining additional pre-encoded tags from said first location.

27. A method as recited in claim 22, wherein said retail environment may be one selected from a group including a fixed store, a site available over a global communications network, a kiosk location or combinations thereof.
